(19) United States
(12) Patent Application Publication
(10) Pub. No.: US 2015/0199726 A1
(43) Pub. Date: Jul. 16, 2015

(54) Mobile Advertising Wrapper

(71) Applicants: Farid Jawde, Brooklyn, NY (US); Shinji Kim, Brooklyn, NY (US); John Todd Coleman, Brooklyn, NY (US)

(72) Inventors: Farid Jawde, Brooklyn, NY (US); Shinji Kim, Brooklyn, NY (US); John Todd Coleman, Brooklyn, NY (US)

(73) Assignee: YIELDMO, INC., New York, NY (US)

(21) Appl. No.: 14/668,937

(22) Filed: Mar. 25, 2015

Related U.S. Application Data
(60) Provisional application No. 62/059,974, filed on Oct. 5, 2014.

(51) Int. Cl. G06Q 30/02

(52) U.S. Cl. CPC G06Q 30/0267; G06Q 30/0276; G06Q 30/0277

(57) ABSTRACT

An advertising system and method is provided for serving advertisements on mobile devices which wrap a page or an application on which they are served. The advertisement may include a wrap portion, a header portion, a footer portion and/or an in-content portion.

### CROSS REFERENCE TO RELATED APPLICATIONS

This application claims the benefit of the filing date of U.S. provisional patent application No. 62/059,974 entitled “Mobile Advertising Wrapper”, which was filed on Oct. 5, 2014, by the same inventor of this application. That provisional application is hereby incorporated by reference as if fully set forth herein.

### FIELD OF THE INVENTION

The invention relates generally to advertisements on a mobile device and more particularly but not exclusively to formatting mobile advertisements to wrap a page or an application on which they are served.

### BACKGROUND OF THE INVENTION

As a result of the relatively small display space available on mobile devices, a tension exists among mobile advertisers and consumers. Mobile advertisers want access to as much of the limited viewing screen as possible while still providing a positive experience to the consumer, while consumers typically find existing mobile advertisements to be overly intrusive.

Mobile ads, such as the Adhesion unit from the Interactive Advertising Bureau (FIG. 1) are designed to provide maximum presentation area for marketers on mobile devices, but the general consensus is that these advertising formats are not well received by consumers. They tend to scroll with the page and are either difficult to or not provided with the ability to dismiss.

It would thus be advantageous to create a mobile advertisement format that maximizes ad space on mobile devices but minimizes the invasiveness and disruptiveness in the viewing experience. It would also be advantageous to provide such a mobile advertisement format that is flexible enough to operate on various mobile formats.

### BRIEF SUMMARY OF THE INVENTION

Many advantages of the invention will be determined and are attained by the invention, which in a broad sense provides digital advertisement systems and methods which maximize ad space while minimizing disruptiveness to the viewer. In one or more embodiments the system receives advertising content from the advertiser (e.g. wrapper image, words, links, device type, background color, header image/top cover, footer image, in-content image, animation(s), and optionally additional elements not listed) and combines at least a subset of the content to create an advertisement for display on a mobile device.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is an image of a conventional mobile advertisement;

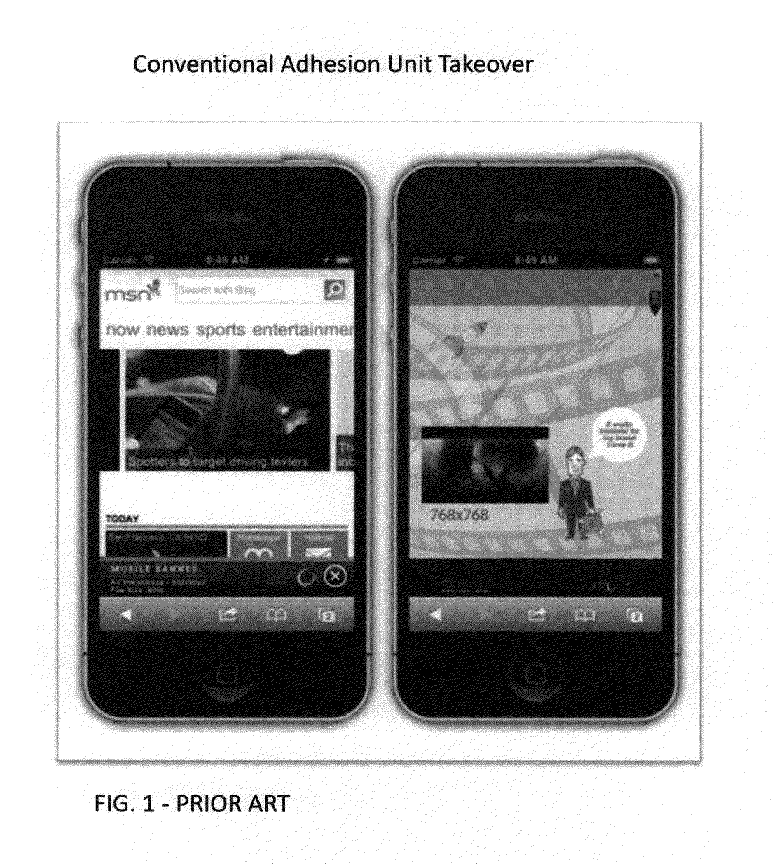

FIG. 2 is an illustration of an advertisement template in accordance with one or more embodiments of the invention;

FIG. 3 is an illustration of an exemplary advertisement in accordance with one or more embodiments of the invention; and,

FIG. 4 is an illustration of a configuration module in accordance with one or more embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

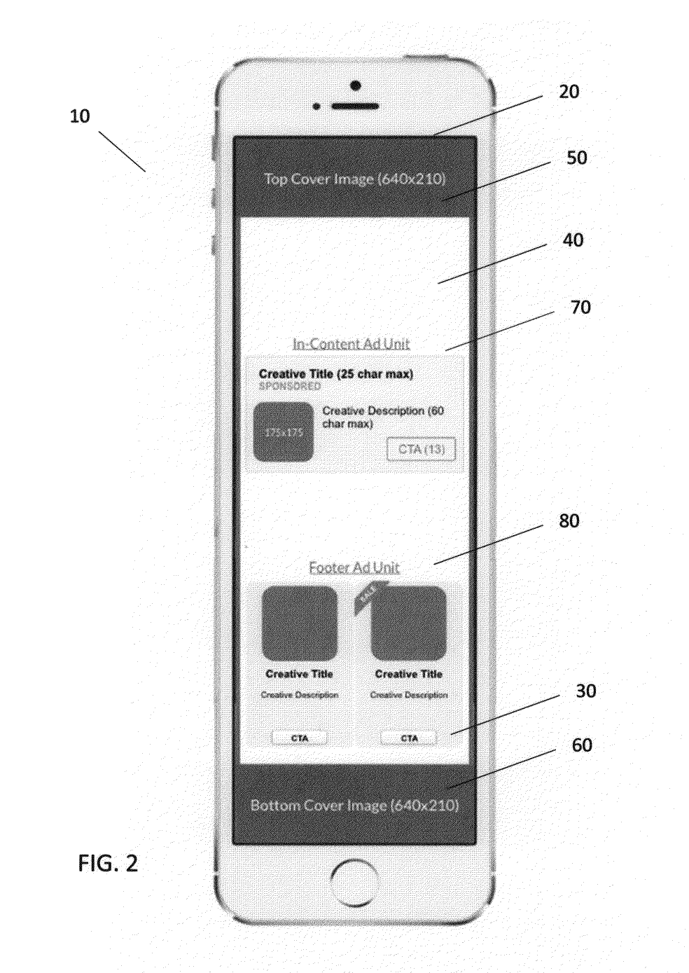

Referring to the drawings in detail wherein like reference numerals identify like elements throughout the various figures, there is illustrated in FIGS. 2-4 mobile advertisement systems and methods for maximizing ad space while minimizing disruptiveness to the viewer. One or more embodiments provides a mobile advertising format (Wrapper) and experience that renders on either a mobile website or mobile application and 1) provides space for marketers to convey a brand message in minimally disruptive ways 2) adapts to the particular device type on which the advertisement is being served and 3) is easily deployed in a packaged manner for publishers and marketers. These advertisements may be employed in a variety of different types of mobile devices such as personal digital assistants (PDA), mobile phones, tablets, e-readers, portable game units, smart watches, etc. The principles and operations of the invention may be better understood with reference to the drawings and the accompanying description.

In a preferred embodiment as illustrated in FIGS. 2-4 the system includes a conventional user interface 10 with a display 20 and conventional input device 30 for populating new advertisement format template(s) 40 (FIG. 2) with general advertisement elements such as background color, image(s), animation(s), words, links, device type, top cover/header image 50, bottom cover image 60, in-content advertisement 70, and footer advertisement 80. While a mobile device with a touchscreen is illustrated in the figures, the invention is not so limited. Many mobile devices include a standard keyboard or a non-standard keyboard or a detachable keyboard and/or a mouse or some other form of pointing device. All of these various input devices 30 are considered to fall within a scope of the invention. The remaining description will focus on a touch screen device however, those skilled in the art will understand that the description is equally applicable to other input devices 30.

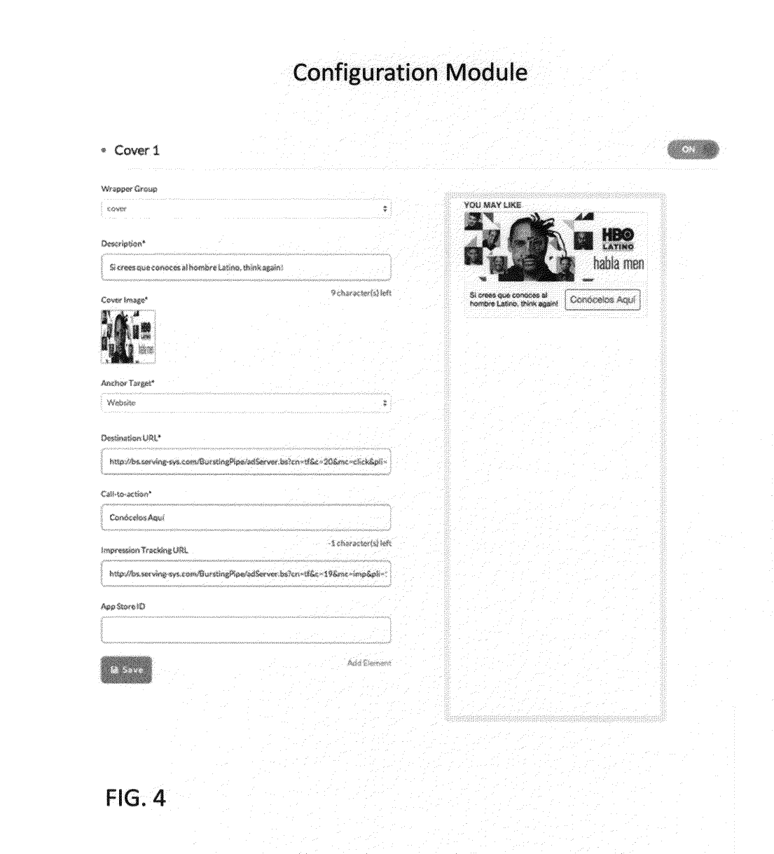

The advertisement configurations are enabled through an administration/configuration tool FIG. 4, and invoked on selected elements of a publisher's website or app. Those skilled in the art will recognize that additional or fewer advertisement elements could be employed and still fall within a scope of the invention.

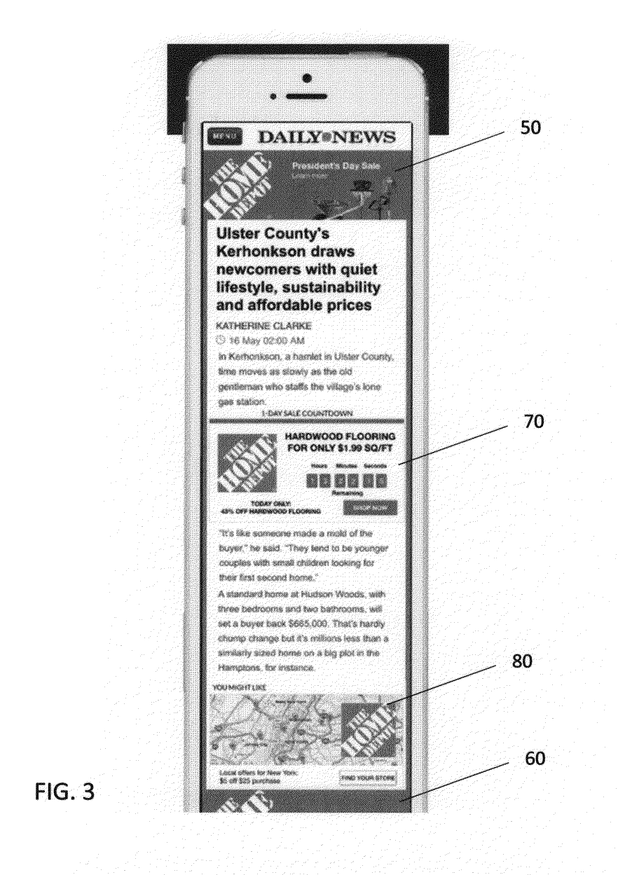

At least a subset of the elements is/are combined to create a unique advertising experience (e.g. in a footer advertisement 80, the marketer can provide a “view our locations on a map” footer, and in-stream/in-content 70 within the content of the article, the marketer can highlight a particular product or video which can be acted on by the user) (FIG. 3). Those skilled in the art will recognize that the footer advertisement content 80 and in-stream advertisement content 70 are design choices and are not limited to those disclosed in the above examples. For example, there may be more than one footer advertisement and/or one or more in-stream advertisement,

Publishers are provided with code to generate the wrapper, which is either a Javascript tag used for the mobile web, or a software development kit (SDK) if the target for the wrapper is a native application (app). The code is then inserted directly on the publisher page or within the publisher's application which enables access to core elements, such as the document object model (DOM) structure if a web page or the view hierarchy an app which can then be configured for construction of the advertisement. A configuration module (FIG. 4), which allows for administration and provisioning of the wrapper format to various publishers, is then used to select targets and supported elements within a publisher's page or application that determine how the wrapper will display. These targets can be variable depending on various Cascading Style Sheets (“CSS”) Media Queries or device oriented profiles, which are used to alter content for various screen sizes. This deployment configuration allows for easy extendabilty of the

Wrapper across multiple publishers and device types, while only receiving a single set of assets from the advertiser. Thus the assets provided by the advertiser can be extended to format and display correctly on different devices because of the designed Wrapper template's capability and the ability to integrate the wrapper elements.

In operation, the wrapper is typically invoked by a user's first visit to the mobile web page or view within an app. Those skilled in the art will recognize that the trigger need not be a first visit but could be any trigger (e.g. click a link, roll over a link, scroll etc) selected as a design choice and still fall within a scope of the invention. Once invoked, the content of the page (or possibly a portion of the page) is encapsulated by the advertisement as illustrated in FIG. 3 and the user is presented with interaction options for the advertisement and/or the content. For example, the user may be provided with one or more of the following options and/or additional options not listed:
Option to tap, swipe, view images, videos or graphics. Interacting with the graphics preferably will invoke an action from the Wrapper (e.g. start a video, change the look and feel of the Wrapper content, Link to another site/source) although it is not required. Additionally or alternatively, interaction with an image and/or video may invoke an action.
Option to view the content in a different presentation, which is typically an easier to read format.

The Wrapper elements can optionally be configured to move and/or change based on the device movement (e.g. through integration with the devices gyroscope or location services), or through user-initiated movement. By way of non-limiting examples, the color of the advertisement may change, the orientation of one or more elements may change, the location of elements on the page may change or the entire advertisement may shift to a different advertisement for the same advertiser or for a different advertiser.

Having thus described preferred embodiments of the invention, advantages can be appreciated. Variations from the described embodiments exist without departing from the scope of the invention. Thus it is seen that an advertisement system and method for maximizing ad space while minimizing disruptiveness to the viewer are provided.

Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a

Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A system for serving a digital advertisement for a mobile device, the system comprising:
a processor based device which includes a display and an input device;
a template including a plurality of fields, said template configured to be displayed on said display and configured to receive input from said input device;
wherein at least one of said plurality of fields is an element of an advertisement;
said element being employed to create an advertisement for display on a mobile device; and
said advertisement configured to wrap a content displayed on said mobile device while providing the ability for the viewer to modify said advertisement.

2. The system according to claim 1 further comprising a code configured to be entered into a webpage which enables access by said processor based device to core elements on said webpage.

3. The system according to claim 1 wherein said advertisement includes a footer portion and an in-stream portion.

4. The system according to claim 1 further comprising a code configured to be entered into a mobile application.

5. The system according to claim 1 further comprising a configuration module for administration and provisioning of said wrapping advertisement.

6. The system according to claim 1 wherein said advertisement includes a footer portion and an in-content portion.

7. A method for creating an advertisement for a mobile device, the method comprising:
placing a code within a mobile webpage, said code having the ability to interact with at least one core element of the webpage,
receiving in a template at least one element of a digital advertisement;
said code employing said at least one digital advertisement element and said at least one core element to create an advertisement capable of being displayed with a content on said webpage;
said advertisement wrapping said content; and
said advertisement integrating with said webpage.

8. The method according to claim 7 further comprising querying said webpage to determine a configuration for said advertisement.

9. The method according to claim 8 wherein said configuration includes a dimension of said advertisement.

10. The method according to claim 7 wherein said querying is performed using a cascade style sheet (CSS).

11. The method according to claim 7 further comprising configuring said advertisement to change in response to a movement of said mobile device.

12. The methods according to claim 11 wherein said change includes a change in a color of said advertisement.

13. The methods according to claim 11 wherein said change includes a change in a content of said advertisement.

14. The methods according to claim 11 wherein said change includes a change in an orientation of said advertisement.

15. The method according to claim 7 further comprising receiving in a configuration module a provision for said advertisement.

16. The method according to claim 15 wherein said provision includes selecting a target for said advertisement.

17. The method according to claim 7 further comprising setting a trigger event which causes said wrapping advertisement to be displayed.

18. A system for creating an advertisement for a mobile device, said system comprising:
a webpage configured to display on a mobile device;
a code embedded within said webpage; wherein said code is configured to receive at least one element of an advertisement and generate from said element an advertisement which is integrated with said webpage; and
a configuration module in communication with said code, said configuration module capable of determining a format of the advertisement.

19. The system according to claim 18 wherein said advertisement includes a footer portion and an in-content portion.

20. The system according to claim 18 further comprising setting a trigger which causes said advertisement to be displayed.
